(19) United States
(12) Patent Application Publication
(10) Pub. No.: US 2023/0088078 A1
(43) Pub. Date: Mar. 23, 2023

(54) SMARTPHONE SIDE LIGHT

(71) Applicant: ALVA ARTS, INC., Los Angeles, CA (US)

(72) Inventors: Justin Hamilton Cross, Sykesville, MD (US); Michael Joseph McCarthy, Olathe, KS (US)

(21) Appl. No.: 18/059,709

(22) Filed: Nov. 29, 2022

Related U.S. Application Data
(63) Continuation of application No. PCT/US2021/035151, filed on Jun. 1, 2021.
(60) Provisional application No. 63/033,206, filed on Jun. 1, 2020.

(51) Int. Cl. H04M 1/02; H04M 1/22; H04M 1/72436

(52) U.S. Cl. CPC H04M 1/0281; H04M 1/22; H04M 1/0264; H04M 1/72436; H04M 2250/12

(57) ABSTRACT

A smartphone or smartphone case with features capable of being used while running, walking, and other outdoor activities is provided. The features may include a light positioned on a sidewall of the smartphone case or the smartphone itself. Such a side light allows the user to hold the phone in a natural position with a front or rear of the smartphone facing a user's palm, while the light on the sidewall faces forward, allowing the user to comfortably hold the smartphone and keep the wrist at a natural and comfortable position while lighting the path before them.

### FIELD

The present invention relates to smartphone cases, smartphone features, and smartphone applications especially as those devices relate to runners, and recreational users of smartphones.

### BACKGROUND

Smartphones created a second wave of personal computing. Beyond the entry of the personal computer (PC) into everyone's home in the 1990's, Apple® corporation brought a personal computer to everyone's pocket in the first decades of the 2000's—the iPhone®. Amazingly, the applications and features of iPhones and competing brands of smartphones (collectively known herein as “smartphones”) in many respects performed better than PC's. Nevertheless, the smartphones of today still lack some practical features, durability, and ergonomics, especially in relation to running or the performance of recreational activities while carrying smartphones.

People who run or enjoy recreational activities, often carry their smartphones in their hands, so as to quickly take advantages of the many features of these devices. For example, many runners use smartphone applications while running, such as to track their running and pace through satellite linked features, for safety features, for communication while running, for listening to music, and for taking video and photos. Many of these features are used while actually running or moving, instead of stopping to use the features.

However, using and activating the features of a smartphone while performing physical activity, especially at maximum effort, or during competition, is difficult and often requires the user to slow down to operate such features. In other words, the functional features or ergonomics of smartphones have not been designed for users performing physical activities such as running or users performing recreational activities, such as, skiing, hiking, and mountain climbing.

### SUMMARY

There remains a need for new features of smartphones and smartphone cases that improve and/or add movement-friendly functionality to aid users performing physical or recreational activities while carrying smartphones.

In a first aspect, the present invention provides an accessory that is attachable to a smartphone and includes a case for a smartphone including various features for use while performing physical and recreational activities. The case may be formed of a body having a rear to cover at least a part of the smartphone, and a sidewall extending from the rear to cover at least a part of an edge of the smartphone. A light source is attached to or incorporated into the sidewall of the case (a side light) and in a preferred embodiment the light source will project outward from the exterior of the sidewall to allow a user to direct the light source in a forward direction while the user is holding the device in a natural position for performing physical or recreational activities, that is, without the wrist turned inward.

In a second aspect, the present invention provides features and or applications of a smartphone itself for users performing physical or recreational activities while carrying smartphones. In another aspect, a smartphone is provided having a light source attached to a sidewall, or a light source integrated into a sidewall, of the smartphone itself to allow a user to direct light in a forward direction while the user is carrying the device in a natural position, that is, without bending their wrist. The device is formed of a body having a rear wall, front, and sides extending around the perimeter between rear and front.

### BRIEF DESCRIPTION OF THE DRAWINGS

FIG. 1 depicts the hand of a user U holding an accessory of the present invention in combination with a smartphone (not shown) while projecting light L from the side.

FIG. 2A is a rear perspective view of an embodiment of an accessory of the present invention for use with a smartphone.

FIG. 2B is the alternative side view of the accessory of FIG. 2A.

FIG. 3 is an enlarged rear perspective view of the accessory of FIG. 2A, with portions broken away.

FIG. 4 is a rear perspective view of an accessory for use with a smartphone, in a further embodiment.

FIG. 5 is a rear perspective view of an accessory for use with a smartphone, in a further embodiment.

FIG. 6 is a rear perspective view of an accessory for use with a smartphone, in a further embodiment.

FIG. 7 is a rear perspective view of an accessory for use with a smartphone, in a further embodiment.

FIG. 8 is a side view of an accessory for use with a smartphone, in a further embodiment.

FIG. 9 is a perspective view of a user carrying a smartphone equipped with a side light, or a case surrounding the smartphone equipped with a side light.

FIG. 10 is a front view of a user carrying a smartphone equipped with a side light, or a case surrounding the smartphone equipped with a side light.

FIG. 11 depicts the hand of a user U holding a smartphone of the present invention capable of projecting light L from the side.

### DETAILED DESCRIPTION

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

As used herein, the term “smartphone” is a broad term, and is to be given its ordinary and customary meaning to a person of ordinary skill in the art (and is not to be limited to a special or customized meaning), and refers without limitation to a smartphone that performs many of the functions of a computer, typically having a touchscreen interface, internet access, and an operating system capable of running downloaded applications. In addition, for the purpose of this specification a “smartphone” shall include other mobile computing devices which may or may not necessarily include traditional telephone functionality (for example an Ipod®).

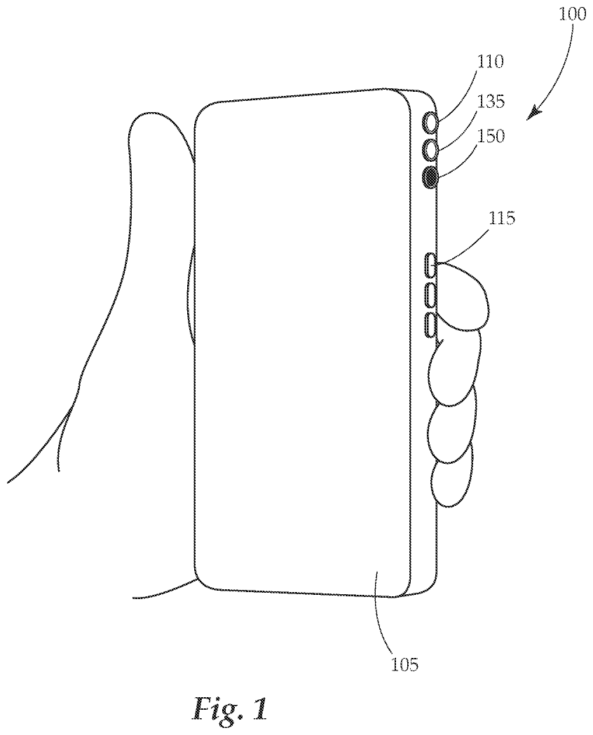

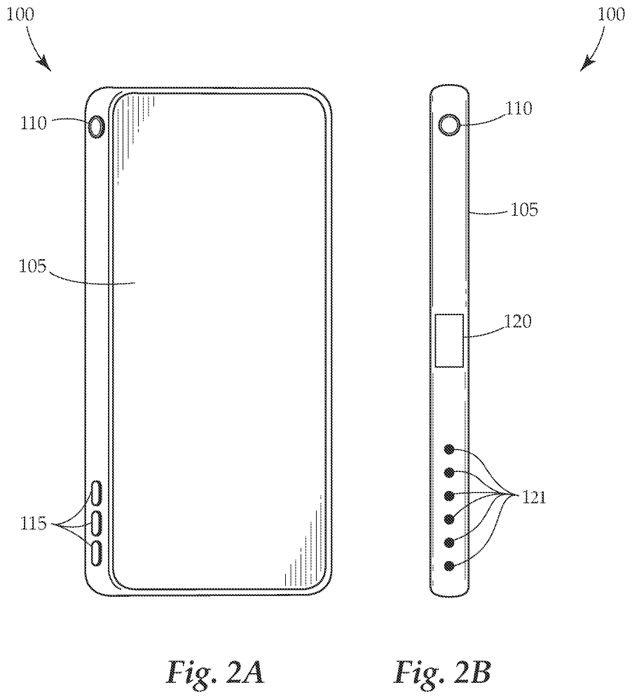

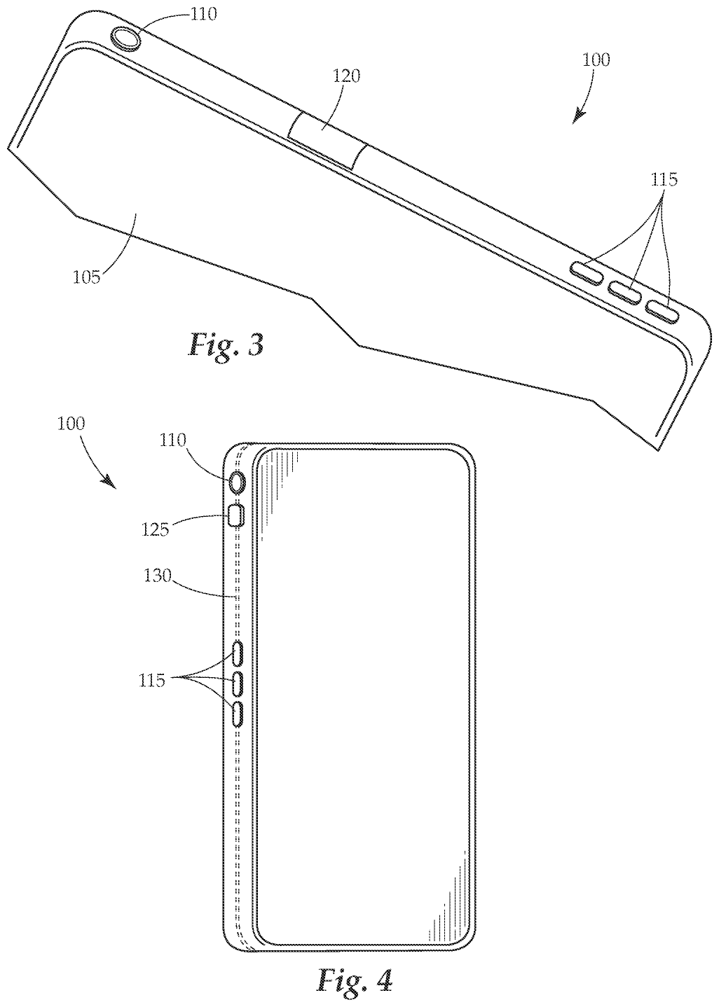

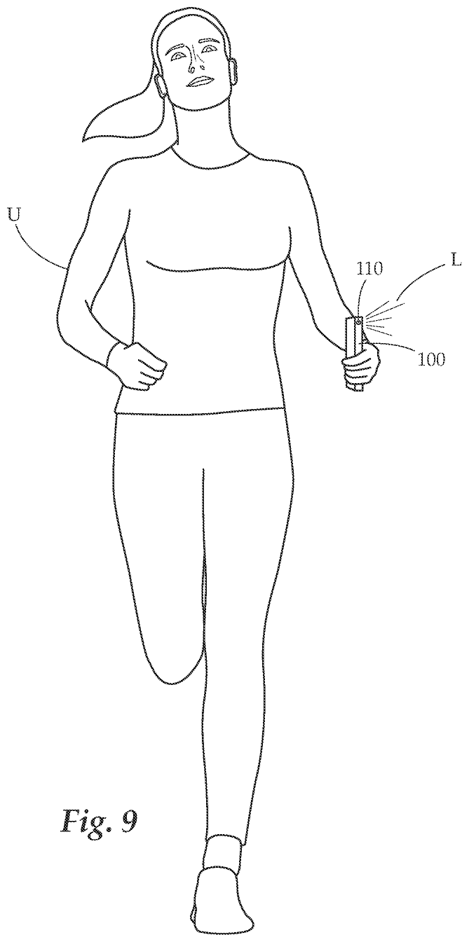

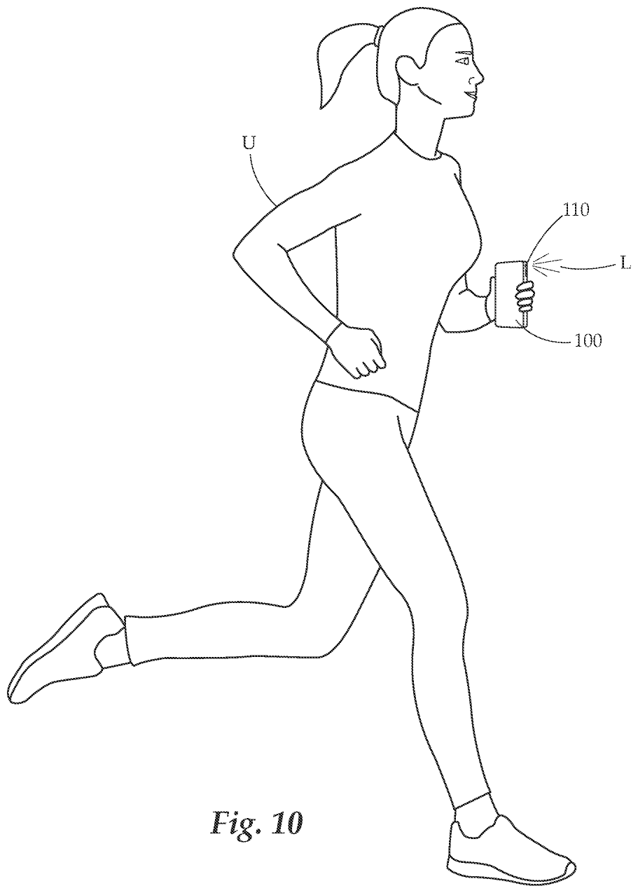

Referring now to FIGS. 1-10, in a first embodiment, the accessory device 100 of the present invention includes a body 105 with a rear portion to cover at least a part of the smartphone, joined with upper and lower and left and right sidewall portions extending from the rear, which together form a chamber (not shown) that is sized and shaped to receive a smartphone therein. On the left or right sides, the device may include one or more light sources, also referred to as illumination elements 110, such as but not limited to a LED (light-emitting diode). In a further embodiment of the present invention the light source may be optimized for certain physical or recreational activities, for example, by modifying or selecting a wavelength, intensity, or energy usage, of the light source best suited for a physical or recreational activity (e.g. running on trails vs running on a track). In a further embodiment of the present invention the light source is coupled with or includes a reflector (not shown). In a preferred embodiment the reflector focuses or channels the light emanating from the light source to illuminate an area which the lighting source is pointed towards. In an additional embodiment of the present invention the reflector coupled with the light source creates a beam of light projecting perpendicular from the side of the smartphone case or smartphone which will effectively illuminate an area at a distance adequate for certain physical or recreational activities. For example, the reflector may be optimized to throw or cast light 15 feet ahead of the user and therefore adequately illuminate the path ahead for a runner running at a pace of 7-minute miles. Adequate illumination as defined herein is illumination at a distance great enough such that a user performing physical or recreational activity has a sufficient amount of time to react when confronted with oncoming obstacles or hazards. In another embodiment of the present invention the reflector is a parabolic reflector. The reflector of the present invention may be smooth or multi-faceted (an “orange peel reflector”). In another embodiment of the present invention the lighting source features of the invention are not covered by a lens or other protective material. In another embodiment of the present invention the lighting source is covered by or coupled with a lens 110 which focuses the light emanating from the light source. In a further embodiment the adjustable lens allows the light emanating from the light source to be focused. In a further embodiment the lens covering the light source is adjustable. In a preferred embodiment of the present invention the lens is optimized to provide adequate illumination for certain physical or recreational activities. In a further embodiment of the present invention, the adjustable lens is optimized to provide adequate illumination at a range of distances adequate for various physical or recreational activities, for example, running and cave-diving. In a further embodiment of the present invention the lens may be adjusted manually, in a further embodiment of the present invention the lens may be adjusted mechanically, for example by pressing a button on the smartphone or the smartphone case. In a further embodiment of the present invention the light source and lens are capable of projecting a beam perpendicular to the side of the smartphone case or smartphone in which the light source is integrated. In a further embodiment of the present invention the reflector, lens, and light source are optimized in combination to facilitate the best possible lighting for certain physical or recreational activities. In a further embodiment of the present invention the light source is coupled with a collimator capable of projecting light in a parallel beam perpendicular to the surface of the side of the smartphone case or smartphone. The collimator may be adjusted manually or mechanically to provide adequate illumination for users U performing physical or recreational activities. In a further embodiment of the present invention the tube of the collimator will be placed inside the smartphone case just above or below the reservoir for the smartphone (not shown) so that the end of the collimator projects from the side of the smartphone case and the body of the collimator is hidden above the smartphone when enclosed in the smartphone case. In a further embodiment, the collimator tube will be placed adjacent to or share a laser (described below) tube hidden above or below the smartphone reservoir in the smart phone case (not shown) so the end of the collimator and laser or collimator/laser project from the side of the smartphone case. It is fully envisaged by the present invention that there may be multiple light sources (side lights), which some or all may or may not include reflectors, lenses, and/or collimators which may function together to cast a brighter and or further traveling beam of light. In one embodiment, the light assembly or assemblies are adjustable to increase or decrease a cast of the beam of light. The multiple light sources may be optimized for a singular or a range of physical and/or recreational activities. In one embodiment of the present invention the light sources will be integrated into the top or bottom sidewalls of the smartphone or smartphone case. In a preferred embodiment of the present invention the light sources will be integrated into the longitudinal side of the smartphone or smartphone case. The illumination elements 110 are configured to be actuated by one or more actuator 115, such as but not limited to buttons or sensors 115 that are located so as to be easily manipulated by the user U, such as via her fingers. In some embodiments, the smartphone case 100 is an attachable cover that snaps around or onto a smartphone, such as by methods known in the art, such that the user U can carry the smartphone coupled with the smartphone case in one hand. The smartphone case 100 includes one or more features, described in greater detail below. Advantageously, the positioning of the one or more features enables the user U to actuate the one or more features with the fingers (see FIG. 1) while holding the body 105 of the smartphone case 100, with the smartphone coupled therein, in a natural or neutral position and without bending or twisting the wrist inward. Thus, the user U can operate the one or more features, such as but not limited to a light source 110, a laser 135, a signal, a vibration, music, a camera 136, a heart rate monitor 120/121, and the like using one or more buttons 115 or switches located on the side of the smartphone case 100, in a natural position, that is without bending or turning the wrist inward. Further, due to the location of one or more features with respect to the body 105, the user U can actuate the one or more features more quickly and accurately, than she would if the smartphone was not coupled with the smartphone case 100. All of the features described above and shown in the figures are applicable to smartphones themselves without cases or coverings. As shown in FIGS. 9 and 10, a user U can be seen carrying the smartphone or smartphone coupled with a smartphone case in a natural position, with the light 110 activated to shine light L.

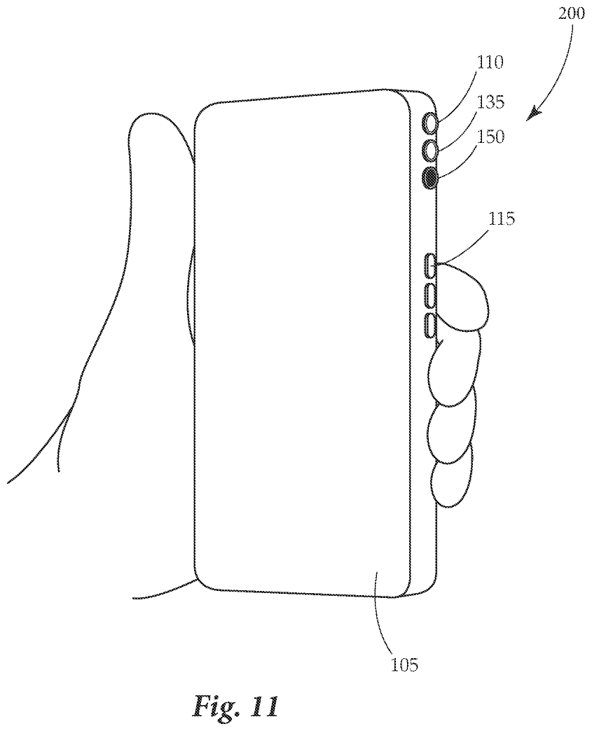

Turning to FIG. 11, an embodiment of the present invention implemented directly into the smartphone is provided. Here, smartphone 200 has illumination elements 110 on a sidewall of the device itself rather than on a smartphone case. The illumination elements are configured to be actuated by one or more actuator 115, such as but not limited to buttons or sensors 115 that are located so as to be easily manipulated by the user U, such as via her fingers. Advantageously, the positioning of the one or more features enables the user U to actuate the one or more features with the fingers while holding the body 105 of the smartphone 200 in a natural or neutral position and without bending or twisting the wrist inward. Thus, the user U can operate the one or more features, such as but not limited to a light source 110, a laser 135, a signal, a vibration, music, a camera 136, a heart rate monitor 120/121, and the like using one or more buttons 115 or switches located on the side of the smartphone case 100, in a natural position, that is without bending or turning the wrist inward. It is expressly noted that any features listed above with respect to the smartphone case may be integrated into a body of the smartphone itself without straying from the scope of this invention. Accordingly, all embodiments discussed with respect to the smartphone case herein are similarly contemplated to be integrated into the smartphone.

In some embodiments, the present invention provides a heart rate monitor 120. For example, a surface portion of one or more of the sides or back of the smartphone case or the smartphone itself 100 are configured so as to be conductive. Accordingly, while the user U is operating the device 100, he can touch the conductive area surface portions 120 for a period of time, so as to collect data for determining the user's heart rate. These conductive areas 120 are in communication with a microprocessor of the smartphone case or the smartphone, allowing it to carry out program instructions to calculate a heart rate based on an input signal from the conductive areas 120. In another embodiment as shown in FIGS. 4 and 8, the conductive material of the heart rate monitor may be formed as a conductive strip 130 which is slightly recessed (as shown in broken lines) from the outer edge of the smartphone case or smartphone to enable protection of the conductive material but to still allow contact with user's hand. The recessed conductive strip 130 may also function and be specifically designed and or optimized to enhance the grip of the smartphone case or smartphone by increasing friction and/or channeling away sweat. In similar embodiments, optical and/or other types of sensors known in the art 121 may take heart rate measurements, or other physiological measurements and may be used without straying from the scope of this invention. Such additional sensors 121 may be placed on the right or left sides smartphone or smartphone case, and may be positioned so that the sensors are in contact with the user's U hand while carrying the smartphone or smartphone case. In a further embodiment, the smartphone case or the smartphone 100 includes a heartrate sensor, such as but not limited to on the side or outer edge of the smartphone case or the smartphone 100 to enable the user U to come in contact with the sensor while holding the smartphone or the smartphone coupled with the smartphone case in a natural position, such as described herein. Advantageously, an included heart rate monitoring feature enables the user U to monitor his heart rate while performing physical or recreational activities. In a further embodiment, the heart rate monitor feature included within a smartphone case is configured to function and operate independently from a coupled smartphone. In another further embodiment, the heart rate monitor feature is configured to function with and is compatible with applications on the smartphone, such as but not limited to performance tracking applications, for example Strava®. In another embodiment, the outer edge or side of a smartphone itself includes conductivity 120, 121, 130 and/or other sensing capability, such as but not limited to a sensor, so as to measure an individual's heart rate. Such an embodiment would be interactive or compatible with applications and/or programs that run on the smartphone itself. In one embodiment of the present invention, the heart rate monitor feature includes distinct recesses and/or metallic surfaces 120 located on one or more in the sides of the smartphone 100, which will sense the user's heart rate. In another embodiment of the present invention, all four sides, or the entire outer edge, of the smartphone case, or the smartphone 100 contains a material capable of sensing a user's heart rate, or other physiological parameters, in such embodiment it may not be apparent that such material has any type of sensor capability, that is, a “cloaked sensor.” In other embodiments, the material capable of sensing a user's heart rate is located only in distinct locations on the smartphone case or smartphone itself 100. Other physiological sensors may include, but are not limited to electrical, optical, ultrasonic, ultraviolet, and other electromagnetic spectrum sensors, chemical sensors, and the like. Such additional physiological sensors may be placed on the smartphone or smartphone case in positions similar to the heartrate monitor described above 120, 130, or in distinct locations separate from the heart rate monitor 121.

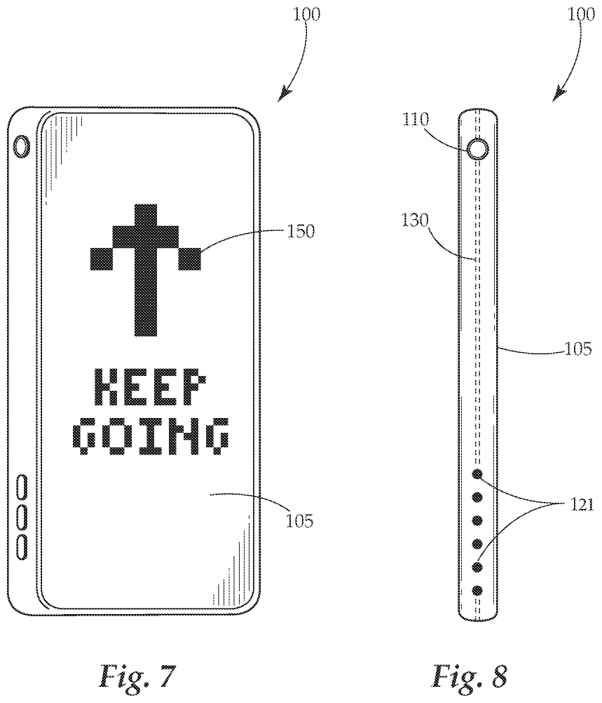

In another embodiment of the present invention, the smartphone case or smartphone itself 100 includes one or more lighting features in addition to the side light. For example, in one embodiment the smartphone case or smartphone itself 100 has lighting features which act as a traffic signal or other type of signal 150. Such lighting features could be provided by LED's embedded into the accessory device 100, or in an alternative embodiment, the smartphone or smartphone case 100 comprises a matrix of LED's covering the entire back panel of the smartphone or smartphone case (See FIG. 7). In one embodiment, the lighting features are controlled by buttons 115 mounted on the outer edge or side(s) of the accessory device 100. Such lighting feature could illuminate in a continuous color, for example green to signal “GO” to others performing physical or recreational activities with the user.

In an additional embodiment of the present invention, the smartphone case or smartphone 100 makes electronic sounds, such as but not limited to bell sounds, whistles, sirens, or tunes, such as to alert and/or to communicate with others or animals (e.g. dogs and horses) near the user U, such as while performing physical or recreational activities. In another embodiment, an application on the smartphone itself enables the user U to actuate emission of electronic sounds to alert and/or communicate with others while performing physical or recreational activities. In some embodiments, the smartphone case or 100 or the smartphone itself via an application emits sounds to communicate or alert dogs, horses or other animals nearby. Such dog alerting noises may be optimized such that the dogs will not be startled by a runner approaching from behind rapidly. In an additional embodiment of the invention the sounds will be optimized to be distinct and quickly relay information to other human beings. In another embodiment of the present invention the smartphone case will make a distinct noise to identify the branding of the smartphone case or smartphone application.

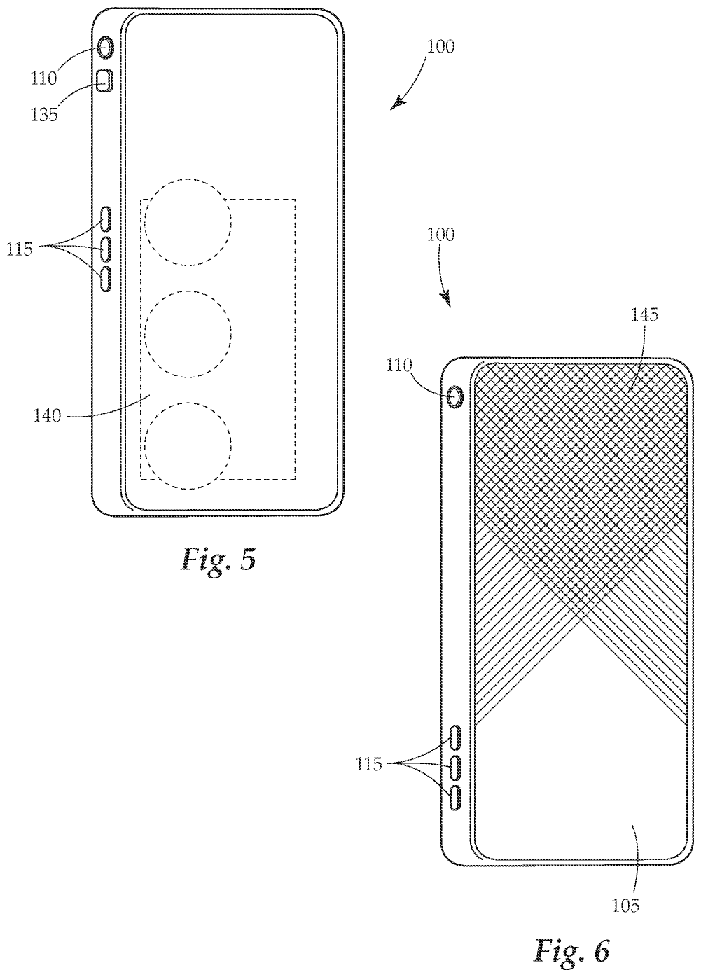

In one embodiment of the present invention the features of the smartphone case will be powered by batteries located within the smartphone case. This can be seen in FIG. 5. In this view, the case body 105 contains batteries 140 which power the light and or lights. In another embodiment the smartphone case will be powered by a battery which also serves as an alternative or back up battery for the smartphone. In either of the above embodiments the batteries may be charged while charging the smartphone directly, such as, for example, simultaneous charging. In an alternative embodiment of the invention the smartphone case will be powered by the battery within the smartphone. In a further embodiment of the present invention the smartphone case will include a solar panel to charge the smartphone case and/or the smartphone.

In one embodiment of the present invention the smartphone case will connect into the smartphone through an accessible port of the smartphone (e.g. USB C). In another embodiment of the present invention the smartphone case will connect into the smartphone through an accessible port and include a separate port to serve as a relay. In another embodiment of the present invention, the female port of the smartphone will be connected with a male connection of the smartphone case followed by a female port on the exterior of the smartphone case in the same or nearly the same position to allow connectivity and charging to the smartphone case but also allowing the charging port to remain in nearly the same position as on the body of the s mart phone.

In one embodiment of the invention the smartphone case will include a microprocess or to control the features of the smartphone case such as the heart rate monitor and side mounted lights. In an additional embodiment the microprocessor of the smartphone case will connect to and function with applications or software of the smartphone.

In one embodiment of the present invention the smartphone case is made from a material that will protect the smartphone. In one embodiment of the invention the smartphone case is made out of rubber, plastic, glass, chemically strengthened alkali-aluminosilicate, and or other suitable materials. In one embodiment of the invention the smartphone case encloses only the outer edge of the smartphone and does not cover the front or back of the phone (e.g. a bumper). In another embodiment of the invention smartphone case covers the outer edge of the smartphone as well as the back of the smartphone. In a further embodiment the smartphone case covers the sides, front, and back of the smartphone completely. In a separate embodiment of the present invention the smartphone case covers portions of the smartphone while allowing functional features, e.g. the fingerprint scanner, to remain uncovered. In a further embodiment of the present invention the smartphone case is capable of relaying information or touch gesture inputs through the smartphone case, for example, a glass or plastic covering of the smartphone may be such that the touchscreen is still functional despite being covered, additionally for example the sides of the smartphone may be covered however, they will allow the smartphone buttons to be operated.

In one embodiment of the invention the smartphone case includes outwardly projecting buttons 115 from the side of the smartphone case. In another embodiment of the invention the smartphone case itself is capable of being squeezed to control certain features or functions of the smartphone case or smartphone. In an additional embodiment of the present invention the smartphone case has any type of physical controls or switches in alternative to traditional push buttons switches, for example, slides, or a shake switch, to control and activate features of the smartphone case or smartphone applications. For example, in one embodiment the entire body of the smartphone case may be shaken in a downward direction to quickly activate the side light feature 110, or alternatively the LED matrix 150. In some embodiments, the LED matrix 150 may be controlled by a button or button on the smartphone or smartphone case. In another embodiment, the LED matrix 150 may be in electronic communication with the smartphone, and a processor of the smartphone may be operable to control operation of the LED matrix via, for example, a user input into the user interface of the smart phone and/or automatically depending on sensed conditions by the smartphone. In a further embodiment the buttons or physical controls or switches will be directly adjacent to, surrounding, or directly covering the buttons of the smartphone. It is contemplated herein that the buttons of smartphones have been designed to be in the most ergonomic position available for a user, and/or possess the best location for buttons, the present invention therefore envisions the use of double buttons placed on or near or over the smartphone buttons to control the features of the smartphone case. Such “double buttons” or secondary buttons could be controlled by less physical force than required to activate the underlying smartphone button or could be controlled by a differing type of gesture for example a swipe down on the outside of the smartphone case at the location of the smartphone button would activate the side light, however such movement would not activate the underlying smartphone button. In a further embodiment of the present invention the buttons or physical controls or switches of the smartphone case may be reassigned to perform different functions.

In one embodiment of the invention the invention will include a smartphone application which works with the smartphone case and its various features. In an additional embodiment of the present invention the smartphone case may be connected directly to a PC for downloading or uploading information.

In another embodiment of the present invention the outer edge of the smartphone case will have a higher friction coefficient to enhance gripping while sweating or performing recreational activities. In another embodiment of the invention the cell phone case will have tactile indentations or features that will enhance carrying while sweating or performing recreational activities. In another embodiment of the present invention the smartphone case will be made from a spongy material. In a separate embodiment of the present invention the smartphone case will be oversized or puffy, that is, proportioned at a size larger than standard smartphone cases typically available, to allow easier handling while performing physical or recreational activities.

In another embodiment of the present invention of the outer edge sidewall of the smartphone case will include a laser 135. In another embodiment of the present invention the outer edge wall of the smartphone itself will include a laser 135. In a further embodiment of the invention the side mounted laser will project from the side of the smartphone or smartphone case enabling the user to point the laser while holding the phone in an ergonomic position (e.g. without the wrist turned inward) and while running or performing physical or recreational activities, see FIGS. 9 and 10. In a separate embodiment of the present invention the smartphone or smartphone case laser feature 135 will be coupled with a side light feature 110 and heart rate monitor feature 120. In a separate embodiment of the present invention the laser feature of the smartphone or smartphone case will be capable of measuring distance, such feature may be performed by the smartphone case alone, the smartphone case coupled with an application of the smartphone, or a smartphone itself with an application for taking measurements. In a further embodiment of the present invention the laser measuring will be coupled with the side light in order to set a distance at which to focus the side light through adjustment of the collimator, lens, the reflector, and/or the lighting source. In one embodiment of the present invention a user would point the laser at a distance in front of them, the microprocessor of the smartphone case or smartphone, in either instance, possibly in conjunction with an application of the smartphone, would determine the distance of the laser point and then mechanically adjust the side light to focus on the laser point, or as close as possible to the laser point—a “laser distance side light focusing feature.” In a further embodiment of the present invention, the laser of the smartphone or smartphone case will be capable of communicating with other smartphone cases or smartphones through a sensor, for example through laser pulses which are received through a sensor of the camera application, and which may be read by software. In another embodiment of the invention the laser will project on to a surface with motion for the amusement or distraction of animals. In a further embodiment of the invention the laser can be left on to operate without user interaction to entertain cats.

In a further embodiment of the present invention the smartphone case will have a compartment on the back of the case to hold credit cards, identification cards, and or cash. In a further embodiment of the present invention the compartment feature will be hidden in that the entry to the compartment will be covered by the edge of the case. In a further embodiment of the present invention the compartment will be transparent and allow a user to present the contents (e.g. an identification card) without opening the compartment. In a further embodiment the lighting features in the back of the case (e.g. the led matrix) will illuminate the contents of the transparent compartment. In a further embodiment the case will not be transparent until illuminated with the lighting features within the back of the case. In a further embodiment of the invention the smartphone case's compartment will be designed to hold a vape pen, for example a JUUL®.

In a further embodiment of the present invention the smartphone case covers the entire smartphone. In a separate embodiment of the present invention the smartphone case covers the front and back and sides of the smartphone, while leaving all or some of the features of the smartphone accessible, such as the fingerprint scanner, or the camera and flash of the smartphone. In a further embodiment of the present invention the portion of the smartphone case which covers the touchscreen of the smartphone will relay touches and allow typing and other tactile functions. In a further embodiment of the present invention the smartphone case which covers the entire phone is transparent or partially transparent. In a separate embodiment of the present invention the transparent case contains switchable glass or smart tint. This can be seen in FIG. 6. Switchable glass 145 or smart tint is cable of making the entire case or a portion of the case switch between opaque and transparent. In a further embodiment the switchable glass 145 or smart tint is capable of making various portions of the smartphone case opaque or transparent, for example, the compartment of the smartphone case may be a capable of switching between opaque and transparent so that the identification card within may be read. In a further embodiment the switchable glass or smart tint of the smartphone case functions as a safe for the smartphone blocking some or all of the features of the smartphone and or some or all of the identifying features of the phone until the “combination” is performed to switch the opaqueness to transparency and allow the features of the phone to be operated. Such combination to remove the opaqueness of the smartphone case could be pressing buttons in a certain order, squeezing the case a certain number of times, or using the fingerprint scanner of the smartphone itself. In a further embodiment of the present invention the smartphone case may be integrated with the software and or applications of the smartphone to control the smart tint or switchable glass, for example the facial recognition feature of the smartphone could function to switch the smart tint or switchable glass from opaque to transparent. Specifically, in a particular embodiment, a case may be provided formed of a body 105 which defines a cavity to receive a smartphone. The body is formed of a rear and sidewall extending up from the rear around the cavity. A front 145 of the case connects to the sidewall and covers at least a portion of a screen of the smartphone. The front 145 may be formed of a switchable glass which can receive a signal to cause it to change from transparent to translucent/opaque. A controller such as a switch, microprocessor, or the like may be used to provide the signal to transition the glass between transparent and translucent/opaque modes. This controller may be part of the body of the smartphone case, connected to the microprocessor of the smartphone, or a combination of the two. In a further embodiment, the smartphone case and smartphone may be in electronic communication with each other, and the smartphone may be programmed to only allow transition from the translucent/opaque mode to the transparent mode of the switchable glass upon an authentication. Authentication may include, but is not limited to a camera using facial recognition, fingerprint scanner, touch screen (passcode) input, and the like. Upon receipt of the authentication, the processor or other controller causes the switchable glass front to move to a transparent mode, allowing the user to use the smartphone. In a further embodiment of the present invention the switchable glass will be a component of the smartphone itself and capable of the above-mentioned features for the smartphone case. In a further embodiment the smartphone will be encased in a thin layer of permanent switchable glass or smart tint such that the entire smartphone may be switched to opaque and be unidentifiable, such a complete “blank-out” feature could be a security measure, which will not switch back to transparent (so that the smartphone may be operated) until a certain combination of actions is performed, or identity is confirmed through facial recognition or fingerprint, etc.

In a further embodiment of the present invention the features described above, e.g. the lighting features, LED matrix, or transparency to opaque switching feature of the smartphone case or smartphone will function as an alarm system to alert surrounding people that the smartphone has been taken by an unauthorized person. For example, the LED matrix would flash after the gyroscope sensed movement of the smartphone and a sufficient amount of time had passed before the user was authorized. Authorization to handle the phone may be achieved by the user pressing a sequence of buttons, or through the smartphones fingerprint reader, or facial recognition, retinal scanner etc. Such alarm system could also be activated by the reception of an unusual heart rate, or collapse, by the holder of the phone. In a further embodiment such alarm system can be activated quickly by users performing physical or recreational activities to ward-off potential threats (e.g. a “panic mode”). In alternative embodiment of the present invention, the smartphone case or smartphone with an outer edge heart rate monitor or other physiological sensor we be enabled to, or have an application for the purpose of making emergency calls (call 911) upon sensing an unusual heart rate, and or collapse.

In a further embodiment of the present invention the smartphone case has a metal portion capable of adhering to a magnet with significant force to hold the encased smartphone in place. In a further embodiment of the present invention the smartphone case includes a magnet that the smartphone may be mounted to any magnetic surface (i.e. metal surface, such as steal), however, not with so much force that the smartphone may not be released.

In a further embodiment of the present invention the smartphone case or smartphone has a camera (and/or video camera) 150 and flash mounted on the edge of the smartphone case or smartphone so that the camera and flash may be used without turning the wrist inward—a “side camera.” In a further embodiment the camera and flash may be operated by use of buttons also mounted on the side of the smartphone case. In a further embodiment the camera and flash will be positioned on the side of the smartphone or smartphone case such that video may be taken while performing physical or recreational activities. It is envisaged by the present invention by placement of the camera along the side of the smartphone or smartphone case will allow users to live stream physical or recreational events without inhibiting or distracting from their performance. In addition, such video taking capability may serve as a safety feature to ward off potential attackers. It is further envisaged by the present invention, that the side mounted camera video taking capability will be coupled with a light to indicate the camera is recording and or live streaming.

The present invention has been described above with reference to specific embodiments. However, other embodiments than the above described are equally possible within the scope of the invention. Different method steps than those described above may be provided within the scope of the invention. The different features and steps of the invention may be combined in other combinations than those described. The scope of the invention is only limited by the appended patent claims.

All references cited herein are incorporated herein by reference in their entirety. To the extent publications and patents or patent applications incorporated by reference contradict the disclosure contained in the specification, the specification is intended to supersede and/or take precedence over any such contradictory material.

To the extent publications and patents or patent applications incorporated by reference herein contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, unless otherwise expressly stated, should be construed as open ended as opposed to limiting. As examples of the foregoing, the term “including” should be read to mean “including, without limitation” or the like; the term ‘comprising’ as used herein is synonymous with “including,” “containing,” or “characterized by,” and is inclusive or open-ended and does not exclude additional, unrecited elements or method steps; the term ‘example’ is used to provide exemplary instances of the item in discussion, not an exhaustive or limiting list thereof; adjectives such as “known”, “normal”, “standard”, and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. In addition, as used in this application, the articles “a” and “an” should be construed as referring to one or more than one (i.e., to at least one) of the grammatical objects of the article. By way of example, “an element” means one element or more than one element.

The presence in some instances of broadening words and phrases such as ‘one or more’, ‘at least’, ‘but not limited to’, or other like phrases shall not be read to mean that the narrower case is intended or required in instances where such broadening phrases may be absent.

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches. Where a range of values is provided, it is understood that the upper and lower limit, and each intervening value between the upper and lower limit of the range is encompassed within the embodiments.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. A case for a smartphone comprising:
a rear portion and a sidewall portion extending from the rear portion to cover at least a part of an edge of the smartphone to removably engage the case with the smartphone; and
a light source associated with the sidewall portion of the case, wherein the light source projects a light beam outward and approximately perpendicular to the surface of the sidewall.

2. The case of claim 1, wherein the light source is associated with a reflector which enhances a projection of the light beam.

3. The case of claim 1, wherein the light source is associated with a lens which enhances a projection of the light beam.

4. The case of claim 1, where in the light source is associated with a collimator which enhances a projection of the light beam.

5. The case of claim 1, wherein the case further comprises one or more buttons placed on the sidewall portion to control the light source.

6. The case of claim 1, wherein the case further comprises a heart rate monitor, the heart rate monitor comprising at least one conductive strip or sensor on a surface of the smartphone case.

7. The case of claim 1, wherein the case further comprises a biometric sensor positioned on a surface of the smartphone case.

8. The case of claim 1, wherein the case further comprises one or more lasers associated with the sidewall portion of the case, and wherein the laser is positioned to cause a laser beam to project outward and approximately perpendicular to the surface of the sidewall.

9. The case of claim 1, wherein the case further comprises a LED matrix on the rear portion of the case, wherein the LED matrix is controlled by a processor of an enclosed smartphone which is in electronic communication with the LED matrix.

10. The case of claim 1, wherein at least a portion of the case is comprised of switchable glass.

11. The case of claim 1, further comprising a camera associated with the sidewall of the case.

12. The case of claim 1 wherein the light source comprises one or more light assemblies positioned on the sidewall portion of the smartphone case, the one or more light assemblies comprising a LED, reflector, and lens which project a beam of light perpendicular to the sidewall portion of the smartphone case, and where the one or more light assemblies are adjustable to increase or decrease a cast of the light beam.

13. The smartphone case of claim 10 further comprising buttons placed along the sidewall portion which control the one or more light assemblies, and which may be operated while maintaining a beam of light perpendicular to the sidewall portion of the smartphone case in a forward direction.

14. The smartphone case of claim 10 further comprising a heart rate monitor, wherein the heart rate monitor comprises conductive material integrated into a surface of the smartphone case and in communication with a processor of an enclosed smartphone.

15. A smartphone, the smartphone comprising: a body having a rear wall, a front wall, and a sidewall extending around a perimeter of the body joining the rear wall and front wall, the body having widthwise sides and lengthwise sides and the sidewall extending around the widthwise sides and lengthwise sides; a light source positioned on the sidewall and operable to allow a user holding the smartphone to direct light emitted from the light source forward while holding the smartphone with the hand in a neutral position.

16. The smartphone of claim 15 wherein the light assembly comprising an adjustable LED, reflector, and lens, in electronic communication with a processor of the smartphone.

17. The smartphone of claim 15 further comprising a heart rate monitor on the body, the heart rate monitor comprising at least one conductive area on a surface of the body.

18. The smartphone of claim 17 wherein the conductive area is slightly recessed from a surface of the body.

19. The smartphone of claim 15 wherein the rear wall of the body further comprises a LED matrix embedded within its surface, the LED matrix operable to operate in conjunction to create a display for messaging and signaling others.

20. The smartphone of claim 15 wherein one of the rear wall, front wall, and sidewall comprises a biometric sensor in communication with a processor of the smartphone.
